(19) United States
(12) Patent Application Publication
(10) Pub. No.: US 2008/0127022 A1
(43) Pub. Date: May 29, 2008

(54) Method for managing net data of a layout

(76) Inventors: Yu-Chuan Chang, Taipei (TW); Yi-Hsin Hsieh, Taipei (TW); Yung-Chien Cheng, Taipei (TW); Chin-Tien Tseng, Taipei (TW); Cheng-Hsun Ho, Taipei (TW)

Correspondence Address: HARNESS, DICKEY & PIERCE, P.L.C., P.O. BOX 8910, RESTON, VA, 20195, US

(21) Appl. No.: 11/592,120

(22) Filed: Nov. 3, 2006

(51) Int. Cl. G06F 17/50

(52) U.S. Cl. 716/12

(57) ABSTRACT

A method for managing net data of a layout is provided. The method comprises first establishing a net data classification index list in which a net name corresponds to a sub group; comparing a newly added net name with the net data classification index list; classifying the newly added net name to a designated sub group when the newly added net name does not exist in the net data classification index list; establishing an association between the newly added net name and the sub group; and storing the association corresponding to the net name and the sub group in the net data classification index list. Thus the efficiency for managing and utilizing the net data is improved.

### BACKGROUND

1. Field of Invention

The present invention relates to a data management method, and more particularly, to a method for managing net data of a layout.

2. Related Art

During the process of designing the printed circuit board, a prior computer graphic design is an important category of work, wherein the operation of computerizing the printed circuit board mainly comprises two parts, including a pre-placement operation, and a subsequent layout operation.

A part of the net data of a layout is created by the electrical engineer enduing each net with the related information (for example, net width, net length, net type and the like). And the net data are stored in the net information database for use in the later layout. However, the greater part of the net data is provided by the manufacturer. The names or serial numbers of nets defined by each manufacturer are different from each other, such that the net data should be classified by the electrical engineer before being stored in the net information database, or nets essentially the same and having similar net names should be changed to have the same net name. The classifying step substantially comprises first creating a sub group; classifying nets of the same type having different net names into the same sub group; then directing the sub group to the corresponding net type. As such, the net name can correspond to the net type, and the net data are stored into the net information database. However, during the process of classifying, it is always time consuming due to repeated classification, thus it is extremely inefficient to manage and utilize the net data.

Therefore, it has become one of the problems to be solved for researchers how to provide a method for managing net data of a layout to improve the efficiency of managing and utilizing the net data.

### SUMMARY

In view of the above problems, a main object of the present invention is to provide a method for managing net data of a layout. Through program comparison and the classification of newly added net names, the errors and the time caused by manual operation are reduced. Thus the efficiency of managing and utilizing the net data is improved.

Therefore, in order to achieve the above object, the method for managing net data of a layout disclosed by the present invention comprises the following steps. First, a net data classification index list is established, wherein a net name corresponds to a sub group. A newly added net name is compared with the net data classification index list. When the newly added net name does not exist in the net data classification index list, the newly added net data is classified into a designated sub group. An association between the newly added net name and the sub group is established. And the association corresponding to the net name and the sub group is stored in the net data classification index list.

The method further comprises a step of designating the sub group to a corresponding net type after the step of storing the association corresponding to the net name and the sub group in the net data classification index list.

In addition, a classification operation is performed for the newly added net name when the newly added net name exists in the net data classification index list.

By using the method for managing net data of a layout, the net name newly added in every time is selected by a program based on the net data classification index list, and it is classified into a designated sub group, and finally an associated data corresponding to the classified net name and the sub group is added to a net data classification index list, such that the subsequent net data can be classified automatically. Thereby the efficiency of managing and utilizing the net data is improved.

The features and embodiments related to the present invention will be described in detail by a preferred embodiment with accompanied drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, and which thus is not limitative of the present invention, and wherein:

FIG. 1 is a flow chart of a method for managing net data of a layout according to an embodiment of the present invention.

### DETAILED DESCRIPTION

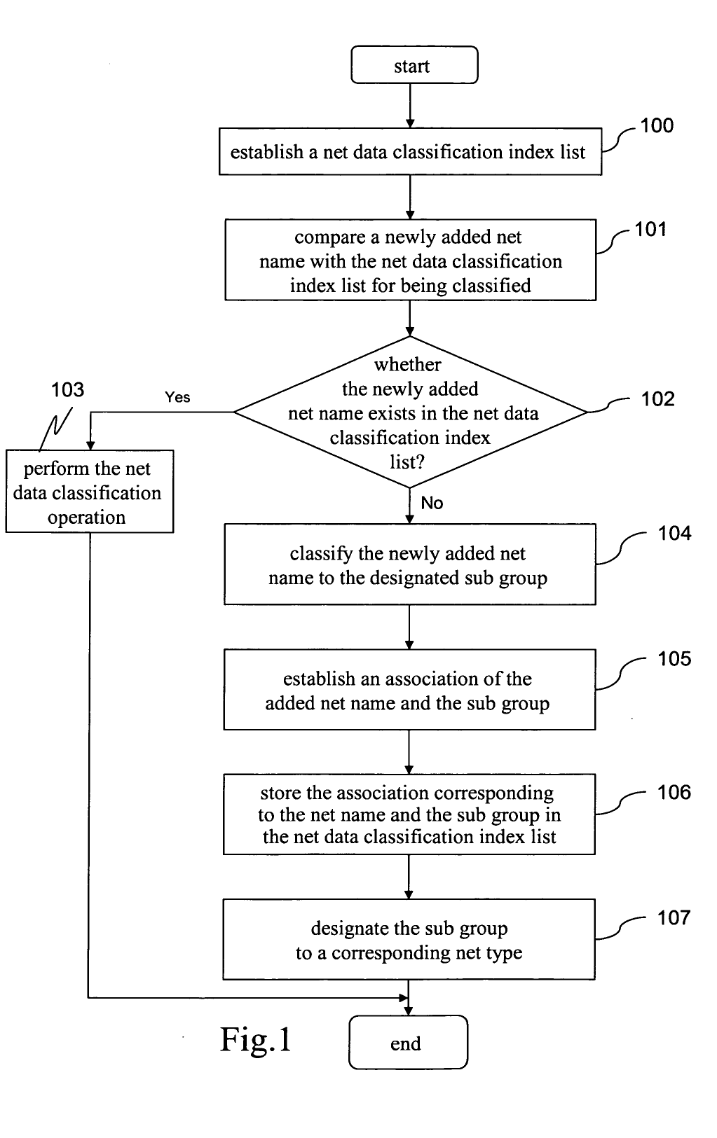

Please refer to FIG. 1 of a flow chart of a method for managing net data of a layout according to an embodiment of the present invention. The method includes the following steps. First, a net data classification index list is established (step 100), wherein a net name corresponds to a sub group. A sub group acts as a data table such that the net data of the same type can be stored in the same sub group according to the net type by a layout operator, and a data storage path information is stored in the net data classification index list. Then, the subsequently newly added net name is compared with the established net data classification index list accordingly to carry out a net data classification operation (step 101), wherein the net name consists of text, symbols, and/or numerals.

Then, it is determined whether the subsequently newly added net name exists in the net data classification index list or not (step 102). When the comparison result shows that the newly added net name exists in the net data classification index list, the net data classification operation is performed according to the net data classification index list (step 103). When the comparison result shows that the newly added net name does not exist in the net data classification index list, the newly added net data is classified into the designated sub group (step 104).

An association between the newly added net name and the sub group is established (step 105), and the data storage path information corresponding to the classified net name and the sub group is established as an associated data. Then, the associated data corresponding to the net name and the sub group is stored in the net data classification index list (step 106). The sub group is designated to a corresponding net type (step 107), wherein the net type can be named according to information such as design name, the circuit board layer numbers, and platforms such as the south bridge chip, the north bridge chip, the central processing unit, and the display chip.

By using the method for managing net data of a layout, the net name newly added in every time is selected by a program based on the net data classification index list, and it is classified to the designated sub group, and finally an associated data corresponding to the classified net name and the sub group is added to a net data classification index list, such that the subsequent net data can be classified automatically. Thereby the efficiency of managing and utilizing the net data is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for managing net data of a layout, comprising:
establishing a net data classification index list, wherein a net name corresponds to a sub group;
comparing an newly added net name with the net data classification index list;
classifying the newly added net name to the designated sub group when the newly added net name does not exist in the net data classification index list;
establishing an association between the newly added net name and the sub group; and
storing the association corresponding to the net name and the sub group in the net data classification index list.

2. The method for managing net data of a layout of claim 1, wherein the method further comprises a step of designating the sub group to a corresponding net type after the step of storing the association corresponding to the net name and the sub group in the net data classification index list.

3. The method for managing net data of a layout of claim 1, wherein a classification operation is performed for the newly added net name when the newly added net name exists in the net data classification index list.
